(19) United States
(12) Patent Application Publication
(10) Pub. No.: US 2025/0111445 A1
(43) Pub. Date: Apr. 3, 2025

(54) SYSTEMS AND METHODS FOR GEOGRAPHY-BASED DATA COLLECTION AND EVALUATION

(71) Applicant: UKG Inc., Weston, FL (US)

(72) Inventor: Richard LIMPKIN, Kilkenny (IE)

(21) Appl. No.: 18/476,716

(22) Filed: Sep. 28, 2023

(51) Int. Cl. G06Q 40/12; G06F 40/174

(52) U.S. Cl. CPC G06Q 40/125; G06F 40/174

(57) ABSTRACT

Disclosed herein are systems and method for geography-based data collection and evaluation. A method may include: receiving institutional criteria for processing payroll transactions for employees in a first geographic location; identifying, from a plurality of data types, a subset of data types that correspond to the institutional criteria; generating at least one rule that assesses whether the institutional criteria is satisfied; generating a graphical user interface that receives data input from an employee; displaying, from a plurality of data entry fields, solely fields associated with the subset of data types on the graphical user interface in response to determining that the employee is associated with the first geographic location; validating the at least one entry using the at least one rule; and generating, on the graphical user interface, an error message in response to determining that the at least one entry does not satisfy the institutional criteria.

### FIELD OF TECHNOLOGY

The present disclosure relates to the field of data storage, and, more specifically, to systems and methods for geography-based data collection and evaluation.

### BACKGROUND

Payroll transactions are an essential part of the world economy as they provide employees with their salaries, employers with their costs, and governmental entities with fees and taxes. As companies have grown to a global scale, the complexities of payroll transactions have risen. For example, an office in a first country may have employees that are taxed differently than an office in a second country, despite both offices being associated with a single company.

One of the issues with managing payroll transactions is viewing, customizing, and validating data in a convenient manner. These issues become more serious when the requirement for each country that a company is based in has unique requirements and laws. For example, all payrolls have a common set of information such as name, address, gross salary, etc. However, certain countries may require additional data depending on their taxation policies. A conventional framework that requests employees to provide all possible data points that a plurality of countries requires will be inefficient on a social and technical level. On a social level, employees end up relinquishing information that the employer technically does not need to complete payroll transactions. On a technical level, when there is a large group of employees, the additional information that is irrelevant for their specific country ends up consuming data storage unnecessarily. More importantly, the additional information causes for a larger attack vector from malicious entities (e.g., hackers) and requires additional processing for security and validation.

### SUMMARY

Aspects of the disclosure relate to the field of data storage In particular, aspects of the disclosure describe methods and systems for geography-based data collection and evaluation.

In one exemplary aspect, the techniques described herein relate to a system for geography-based data collection and evaluation, including: at least one memory; at least one hardware processor coupled with the at least one memory and configured, individually or in combination, to: receive institutional criteria for processing payroll transactions for employees in a first geographic location, wherein the institutional criteria is unique to the first geographic location from a plurality of geographic locations; identify, from a plurality of data types, a subset of data types that correspond to the institutional criteria; generate at least one rule that assesses whether the institutional criteria is satisfied; generate a graphical user interface that receives data input from an employee; display, from a plurality of data entry fields, solely fields associated with the subset of data types on the graphical user interface in response to determining that the employee is associated with the first geographic location; in response to receiving at least one entry in the fields associated with the subset of data types, validate the at least one entry using the at least one rule; and generate, on the graphical user interface, an error message in response to determining that the at least one entry does not satisfy the institutional criteria of the first geographic location.

In some aspects, the techniques described herein relate to a system, wherein the at least one hardware processor is configured to determine that the employee is associated with the first geographic location based on the employee indicating, via the graphical user interface, that the employee works in an office located in the first geographic location or that the employee is a resident of the first geographic location.

In some aspects, the techniques described herein relate to a system, wherein the institutional criteria includes one or more of: name, address, position, salary, a government-issued identifier, an amount of dependents, years of experience, a contract length.

In some aspects, the techniques described herein relate to a system, wherein the at least one hardware processor is configured to display the fields associated with the subset of data types by: displaying a first data entry field of the fields associated with the subset of data types; receiving an entry in the first data entry field; and displaying one of a second data entry field or a third data entry field based on contents of the entry received.

In some aspects, the techniques described herein relate to a system, wherein the at least one hardware processor is configured to: display the second data entry field and hide the third data entry field in response to determining that the contents of the entry indicate that a response in the third data entry field is not required in accordance with the institutional criteria.

In some aspects, the techniques described herein relate to a system, wherein the at least one hardware processor is configured to: receive different institutional criteria for processing payroll transactions for employees in a second geographic location, wherein the different institutional criteria is unique to the second geographic location from the plurality of geographic locations; identify, from the plurality of data types, a different subset of data types that correspond to the different institutional criteria; and generate at least one other rule that assesses whether the different institutional criteria is satisfied.

In some aspects, the techniques described herein relate to a system, wherein the at least one hardware processor is further configured to: generate the graphical user interface that receives data input from an employee, by: displaying, from the plurality of data entry fields, solely fields associated with the different subset of data types in response to determining that the employee is associated with the second geographic location instead of the first geographic location.

In some aspects, the techniques described herein relate to a system, wherein the at least one hardware processor is further configured to store the at least one entry in a database of the at least one memory.

In some aspects, the techniques described herein relate to a system, wherein a given geographic location is one of a town, a city, a country, and a continent.

In some aspects, the techniques described herein relate to a system, wherein the at least one hardware processor is configured to execute a payroll transaction in response to determining that the at least one entry satisfies the institutional criteria of the first geographic location.

In some aspects, the techniques described herein relate to a system, wherein a data type is processed differently in the payroll transaction for the first geographic location than when processed for a second geographic location.

In some aspects, the techniques described herein relate to a method for geography-based data collection and evaluation, including: receiving institutional criteria for processing payroll transactions for employees in a first geographic location, wherein the institutional criteria is unique to the first geographic location from a plurality of geographic locations; identifying, from a plurality of data types, a subset of data types that correspond to the institutional criteria; generating at least one rule that assesses whether the institutional criteria is satisfied; generating a graphical user interface that receives data input from an employee; displaying, from a plurality of data entry fields, solely fields associated with the subset of data types on the graphical user interface in response to determining that the employee is associated with the first geographic location; in response to receiving at least one entry in the fields associated with the subset of data types, validating the at least one entry using the at least one rule; and generating, on the graphical user interface, an error message in response to determining that the at least one entry does not satisfy the institutional criteria of the first geographic location.

In some aspects, the techniques described herein relate to a non-transitory computer readable medium storing thereon computer executable instructions for payroll data validation, including instructions for: receiving institutional criteria for processing payroll transactions for employees in a first geographic location, wherein the institutional criteria is unique to the first geographic location from a plurality of geographic locations; identifying, from a plurality of data types, a subset of data types that correspond to the institutional criteria; generating at least one rule that assesses whether the institutional criteria is satisfied; generating a graphical user interface that receives data input from an employee; displaying, from a plurality of data entry fields, solely fields associated with the subset of data types on the graphical user interface in response to determining that the employee is associated with the first geographic location; in response to receiving at least one entry in the fields associated with the subset of data types, validating the at least one entry using the at least one rule; and generating, on the graphical user interface, an error message in response to determining that the at least one entry does not satisfy the institutional criteria of the first geographic location.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for validating payroll data.

FIG. 2 is a diagram illustrating a graphical user interface (GUI) depicting the geographic region and various indicators associated with data validation.

FIG. 3 is a diagram illustrating the GUI depicting the geographic region and additional indicators associated with data validation.

FIG. 4 is a diagram illustrating the GUI depicting validation results for a plurality of employees.

FIG. 5 is a diagram illustrating the GUI depicting erroneous data values.

FIG. 6 is a block diagram illustrating a system for generating rules for geography-based data collection and evaluation.

FIG. 7 is a diagram illustrating the GUI depicting a plurality of data types associated with a geographic location.

FIG. 8 is a diagram illustrating the GUI depicting data type attributes.

FIG. 9 is a diagram illustrating the GUI depicting rule configuration and generation.

FIG. 10 illustrates a flow diagram of a method for generating a graphical user interface for geography-based data collection and evaluation.

FIG. 11 illustrates a flow diagram of a method for validating an employee entry based on a localization rule.

FIG. 12 illustrates a flow diagram for generating a validation result.

FIG. 13 illustrates a flow diagram for displaying entry fields on the graphical user interface based on the contents of a previously received entry.

FIG. 14 presents an example of a general-purpose computer system on which aspects of the present disclosure can be implemented.

### DETAILED DESCRIPTION

Exemplary aspects are described herein in the context of a system, method, and computer program product for geography-based data collection and evaluation. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

The present disclosure presents a geography-based data collection and evaluation framework (also referred to, in some aspects, as a country specific information (CSI) framework). The framework is utilized to store region-specific (e.g., country, state, city, etc.) information in the processing, validation, and output of payroll transactions. The information stored is different depending on the geographic location, legislative environment, and other country/location specific requirements. The framework provides a user interface that enables users to provide geography-based criteria the form of localization rules.

Conventional methods for storing employee information involve using simple tabular data dictionaries not unlike spreadsheet files. These dictionaries become unsustainable as a company grows in size or expands to multiple geographic locations-requiring significant manual input to ensure consistency, accurate changes, and usable output transformations. The traditional user interfaces for such methods tend to be complicated and cannot be simplified for the end user without a better data model and data taxonomy.

The described framework allows users to efficiently create, store, and configure information. This information is then used in a systematic way to generate outputs for a payroll system ingestion with no human intervention. This drastically reduces the human overhead in the management of data and allows for the reuse of single countries, the scaling of datasets, and cross enriching information for the benefit of all users.

Overall, the framework is a critical part of global processing lifecycle as it is the data template in which payroll data and information is captured for in-country payroll engines to generate a gross to net calculation. The framework data further includes semantic information for payroll additions, deductions, frequency, periods, etc.

Using the user interface of the framework, users can easily work with the geography-based data that is context sensitive (i.e., the data of a Joiner is different than the data of a Leaver in the platform).

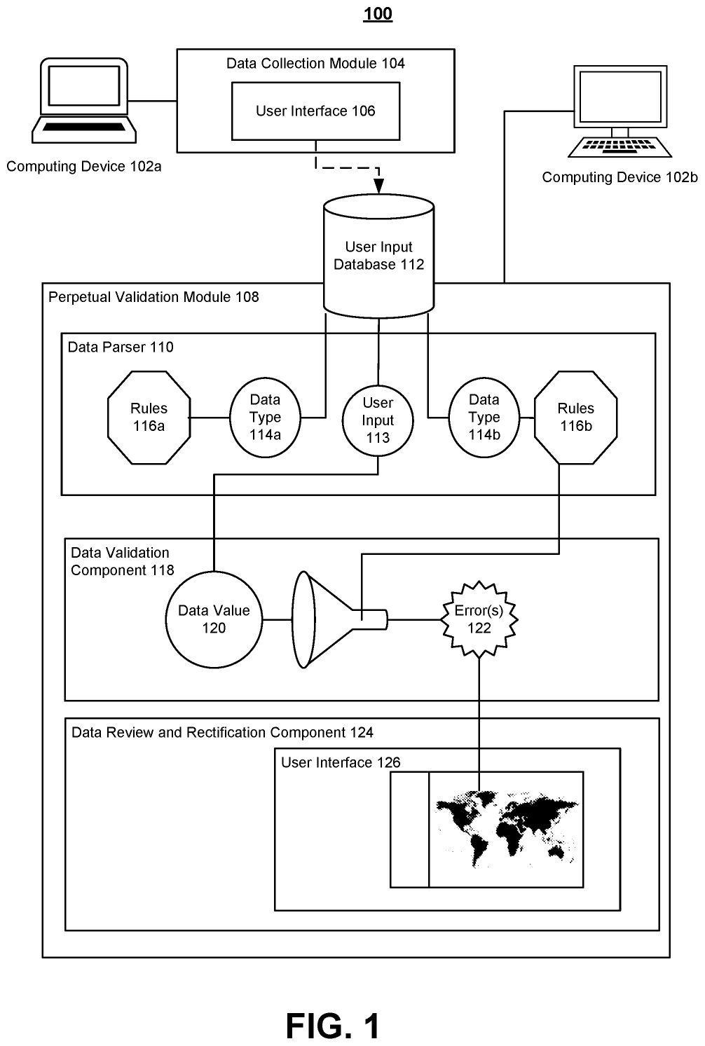

FIG. 1 is a block diagram illustrating a system 100 for validating payroll data. System 100 includes computing device 102a and computing device 102b. For example, computing device 102a may be a laptop, desktop, etc., of an employee and computing device 102b may be a laptop, desktop, server, etc., of a company that monitors payroll information.

Computing device 102a may execute data collection module 104, which includes a user interface 106. User interface 106 may enable an employee to input information about themselves. For example, user interface 106 may be an interface of a web application, a standalone application, a website, etc. User interface 106 may request the employee to input various data values to build an employee profile. Data values include, but are not limited to, name, address, job title, a government-issued identification number, date of birth, marital status, number of dependents, and emergency contact.

Data collection module 104 may be configured to upload the inputs gathered via user interface 106 to a user input database 112. In particular, user input database 112 may be configured and access via perpetual validation module 108. It should be noted that user input database 112 may receive the data values from a plurality of computing devices belonging to different employees. Each data collection module 104 of a respective computing device may be connected to user input database 112 via a network (e.g., a local area network, a wide area network, etc.).

In some aspects, perpetual validation module 108 may be an application split into a thick and thin client application. The thick client application may access user input database 112 and perform validation. In some aspects, the thick client application may be executed on a remote server. The thin client application may receive validation results and generate user interface 126 on computing device 102b.

In an exemplary aspect, data parser 110 retrieves data in user input database 112. For example, perpetual validation module 108 may receive a first user input that includes at least one data value associated with an employee of a company. Suppose that the company is an international retailer that has multiple offices throughout the world. For example, the company may have an office in a country (e.g., France) and another office in a different country (e.g., United States). Suppose that the first user input is associated with an employee from the United States. Accordingly, the at least one data value may include a name, an address, a marital status, and a social security number. The data values may be: “John Doe” as the name, “123 John Doe St., New York 10021” as the address, “single” as the marital status, and “123-45-56789 as the social security number.” It should be noted that the following examples provided are highly simplified for the sake of brevity and understanding. For example, the amount of data values received per user input may be quite large despite only four data values being given in the example.

It should also be noted that rather than be divided into countries/offices, employees may be divided into different pay groups (i.e., a group of employees paid at the same time). Each of those employees may be part of the same office or different offices.

The purpose of gathering these data values is to complete payroll transactions of the company in a given geographic location (e.g., a country). For example, an employee may provide the data values in order to enable a payback deposit in his/her bank account. The payroll transaction may need the data values for identification purposes and to perform calculations of taxation, fees, credits, salary, benefits, etc. For example, the person may have a bi-weekly paycheck deposit of $2000 and based on the information provided in the data values, the company may be able to determine the amount of tax the person owes (e.g., using marital status).

Because a company may be spread out across multiple geographic locations (e.g., cities, towns, states, provinces, countries, continents, etc.), the guidelines for performing payroll transactions may be different depending on the location of the office that the employee works in. For example, the tax rules in the United Kingdom may be different than the tax laws in the United States. Similarly, certain identifiers such as a social security number may be required in one country (e.g., the United States), but not in other countries that utilize a different identification system (e.g., a social insurance number that is used in Canada).

In a conventional approach, a user input is received and validation is not performed until a threshold number of user inputs have been received or when validation is manually launched (e.g., right before performing payroll transactions). This delayed/batch approach is inefficient because it can cause many payroll transactions to get delayed if multiple errors are detected. On a technical level, when validation is performed in one batch, a greater amount of computational resources are expended by a computing device in a short period of time. If a company has several thousands of employees, these shortcomings are exacerbated.

Accordingly, the systems and methods of the present disclosure perform data validation in real-time. For example, when a user enters data values using user interface 106, data collection module 104 may immediately upload the values to user input database 112. Perpetual validation module 108 may detect that user input database 112 has been updated and may be begin validation on the new data values received.

In an exemplary aspect, while receiving user input 113, perpetual validation module 108 validates the at least one data value (e.g., data value 120) of user input 113 in real-time. This involves first determining a data type of the at least one data value. For example, user input 113 may be [John Doe; 123 John Doe St., New York 10021; single; 123-45-56789]. For each data value, data parser 110 may identify one or more data types 114. For example, data type 114a may be “social security number.” The icons for types name, address, marital status, etc., are not shown in FIG. 1.

Each data type and geographic location may be linked to a plurality of localization rules 116. For example, rules 116a may be linked with data type 114a and the first geographic location (e.g., the location of the office or the residential location of the employee). Suppose that user input 113 is for an employee working in the United States. Rules 116a represent localization rule(s) associated with social security numbers in the United States.

It should be noted that the same data type may have different rules in different geographic locations. For example, data type 114b may also be social security number. However, if the geographic location is the United Kingdom, then data parser 110 retrieves rules 116b instead of rules 116a.

Localization rules establish certain criteria for a data value. For example, a rule may query the format of the data value. For example, a social security number is a 9-digit value that includes solely integers. Accordingly, one rule of rules 116a may indicate that the social security number must be nine digits. Other examples of localization rules may be: (1) the social security number cannot have symbols or letters; (2) the social security number should be formatted with 3 digits, followed by 2 digits, followed by 4 digits, (3) the social security number is only issued to persons that are citizens or permanent residents of the United States, etc.

From user input 113, data validation 118 may extract data value 120 (e.g., 123-45-56789) and assess the validity of the data value in view of the criteria of the plurality of localization rules 116a. For example, data validation component 118 may determine that the input social security number has 10-digits. Accordingly, data value 120 has an error 122. Suppose that in another data value, the employee indicated that he/she is not a citizen and is not a permanent resident. Based on the localization rules, this indicates that the employee should not have a social security number. Accordingly, the mere presence of the data value 120 would trigger an error. Errors 122 are provided to data review and rectification component 124, which generates and manages user interface 126.

In an exemplary aspects, data review and rectification component 124 generates, on user interface 126, an indication that the first user input requires review to complete the payroll transactions. In an exemplary aspects, user interface 126 displays a view of a geographical region and the indication is generated in a portion of the geographical region associated with the geographic location of the employee. In some aspects, the geographic location is a country and the geographic region is one or more continents.

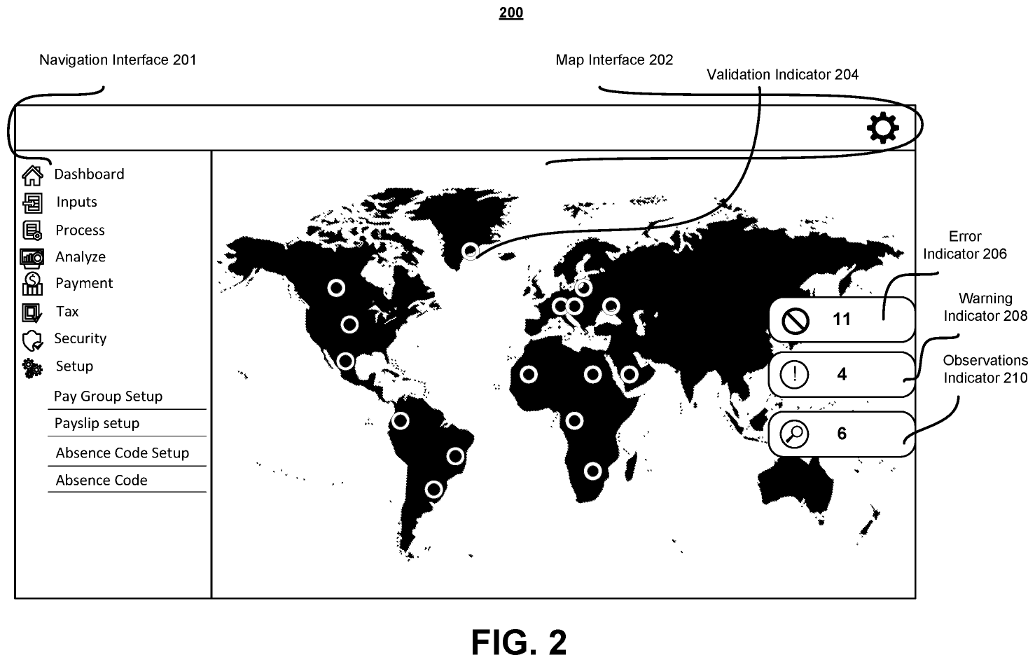

FIG. 2 is a diagram 200 illustrating a graphical user interface (GUI) depicting the geographic region and various indicators associated with data validation. For example, diagram 200 depicts user interface 126 wherein the geographic region includes continents of the world and the geographic locations are individual countries. User interface 126 includes a navigation interface 201, which is a menu that allows a user (e.g., a company payroll officer) to view different types of information and perform various functions. The buttons in navigation interface 201 include dashboard, inputs, process, analyze, payment, tax, security, and setup. A sub-menu of the setup button includes buttons for pay group setup, payslip setup, absence code setup, and absence setup. When the dashboard button is selected, perpetual validation module 108 generates map interface 202.

User interface 126 depicts a plurality of indicators including validation indicator 204, error indicator 206, warning indicator 208, and observations indicator 210. When an employee provides a user input, perpetual validation module 108 validates the information and populates the indicators of use interface 126. For example, when an error is detected, the error count of error indicator 206 is incremented. When an error is resolved, the error count is decremented. As shown in FIG. 2, 11 errors are detected. When a warning is generated, the warning count of warning indicator 208 is incremented. While an error indicates that the invalid data value will prevent a payroll transaction from being completed, a warning indicates that the data value should be corrected even though it may not have an immediate negative affect on the payroll transaction. As an example, a social security number that has 10 digits may trigger an error, but a social security number for a non-citizen/non-permanent resident may trigger a warning. User interface 126 further has an observation indicator 210 that provides information about minor issues such as an incorrect data format (e.g., date should be Nov. 11, 2022 instead of 2022 Nov. 11). A user may select any of error indicator 206, warning indicator 208, and observations indicator 210 to view the erroneous data values, warned data values, and observed data values in a new window of user interface 126.

Validation indicator 204 is a marker generated on each geographic location associated with a given company. For example, a company may have 16 offices distributed over 16 countries. The employees from each office may provide data values for validation. In order to view the employee user inputs of a given geographic location, a user of map interface 202 may select validation indicator 204 of that geographic location.

In some aspects, validation indicator 204 may be represented by a shape such as a circle. In some aspects, validation indicator 204 may be color coded. For example, if a given office has more than a threshold amount of errors (e.g., 20% of entered data values), the indicator may be red. If a given office has less than the threshold amount of errors, the indicator may be green. Any number of visual effects (e.g., shading, textures, colors, etc.) and thresholds (e.g., 10%, 20%, etc.) can be applied to a validation indicator 204. The purpose is to allow the user to highlight the areas that are in immediate need of review.

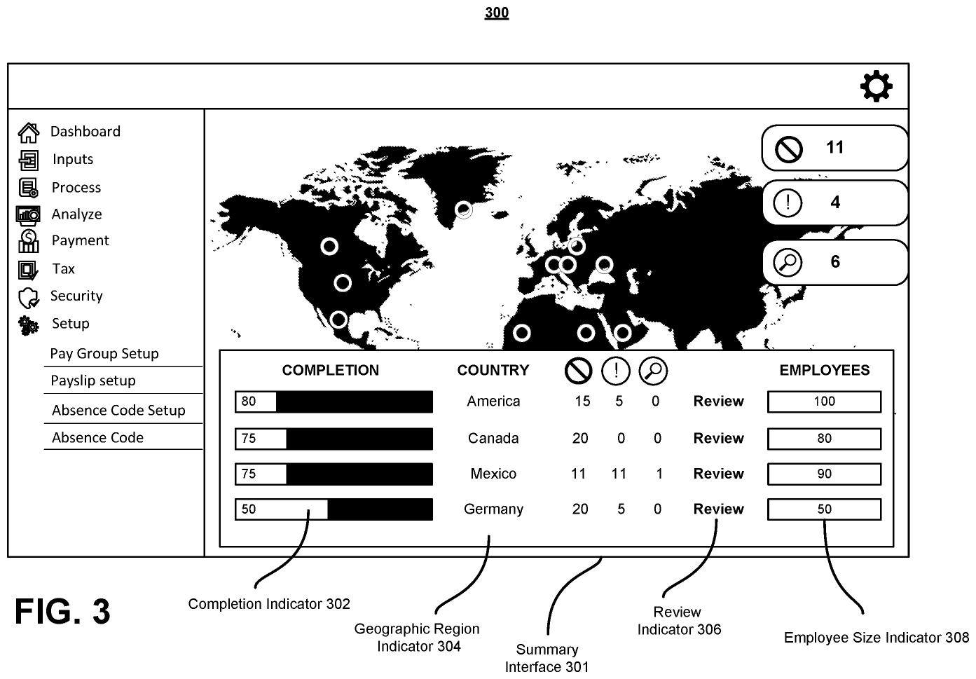

FIG. 3 is a diagram 300 illustrating the GUI depicting the geographic region and additional indicators associated with data validation. In addition to validation indicators, a user may opt to view a summary interface 301. Summary interface 301 lists each of the geographic locations (using geographic region indicator 304) and enables the user to view the individual errors, warnings, and observations counts of the geographic locations. Perpetual validation module 108 may also add a review indicator 306 to each of the items on the list to allow the user to navigate to a new window detailing the data values specific to that geographic location (errors, warnings, observations). In some aspects, summary interface 301 includes an employee size indicator 308 that lists the amount of unique employees in each geographic location. Each of these employees may provide user inputs to generate employee profiles. Completion indicator 302 provides an amount (e.g., percentage) of employee profiles that have no errors/warnings and do not need corrections.

For example, in FIG. 3, Canada has a completion rate of 75% which suggests that 75% of the 80 employees have entered fully valid data and have complete employee profiles (e.g., no errors). This means that 60 employees have entered data correctly and 20 have not. According to summary interface 301, all of those 20 employees have errors in their data values. Referring to Germany, which has 50 employees and a 50% completion rate, summary interface 301 indicates that 25 of the employee rates that remain to be completed include 20 with errors and 5 with warnings.

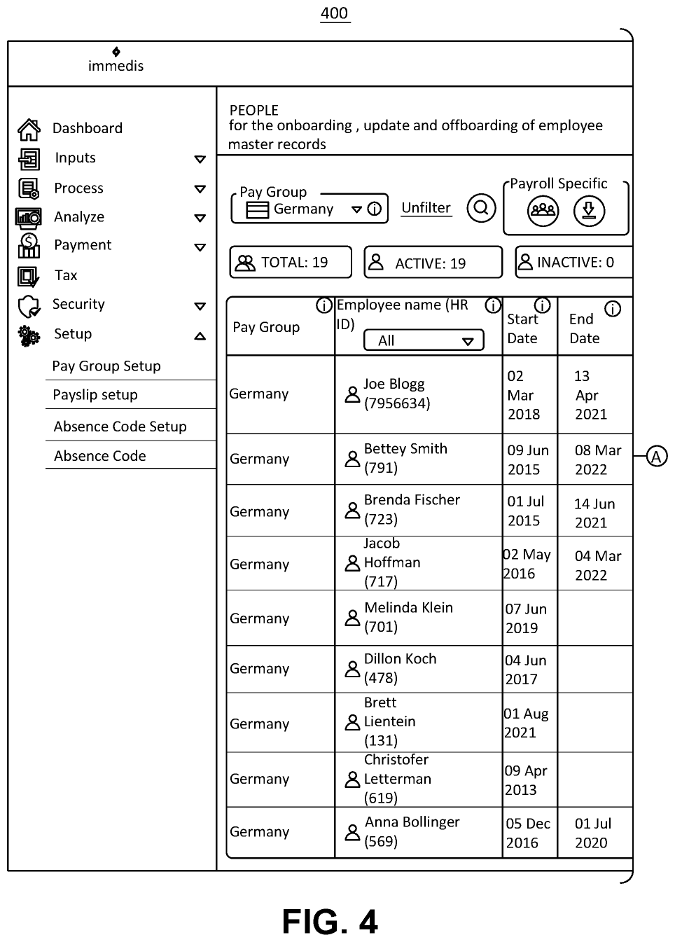

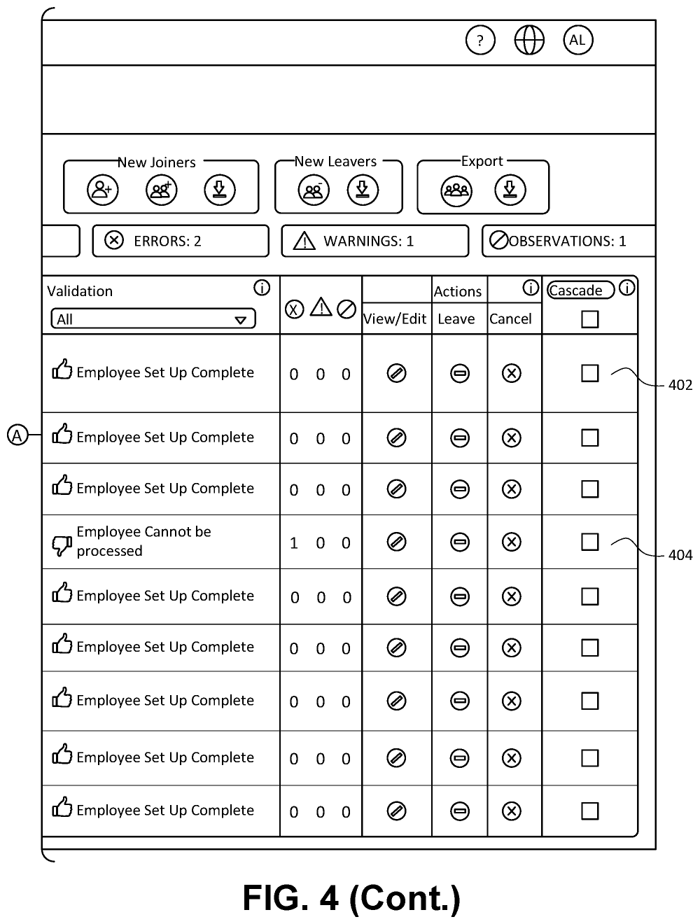

FIG. 4 is a diagram 400 illustrating the GUI depicting validation results for a plurality of employees. Suppose that a user selects the validation indicator 204 of Germany or review indicator 306 of Germany. In response to the selection, perpetual validation module 108 may generate a window that lists a plurality of employee profiles. For example, the first employee is Joe Blogg whose employee identification number is 7956634. The validation results state “employee set up complete,” which indicates that Joe has entered data values that are valid and can be processed for payroll transactions. The entry for Joe is an example of a valid entry 402. In contrast, the fourth entry (e.g., Jacob Hoffman) has a validation result “employee cannot be processed.” The tally columns suggest that there are three errors and one warning in Jacob's employee profile. A user may select the “view/edit” option in Jacob's row to view the employee profile. The entry for Jacob is an example of an invalid entry 404.

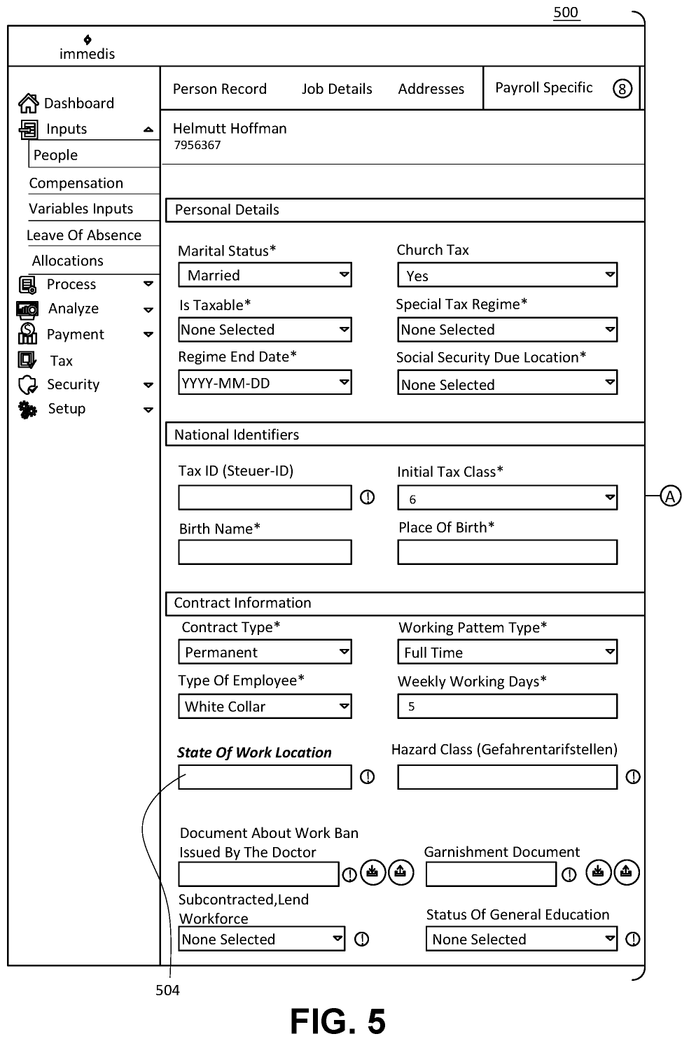

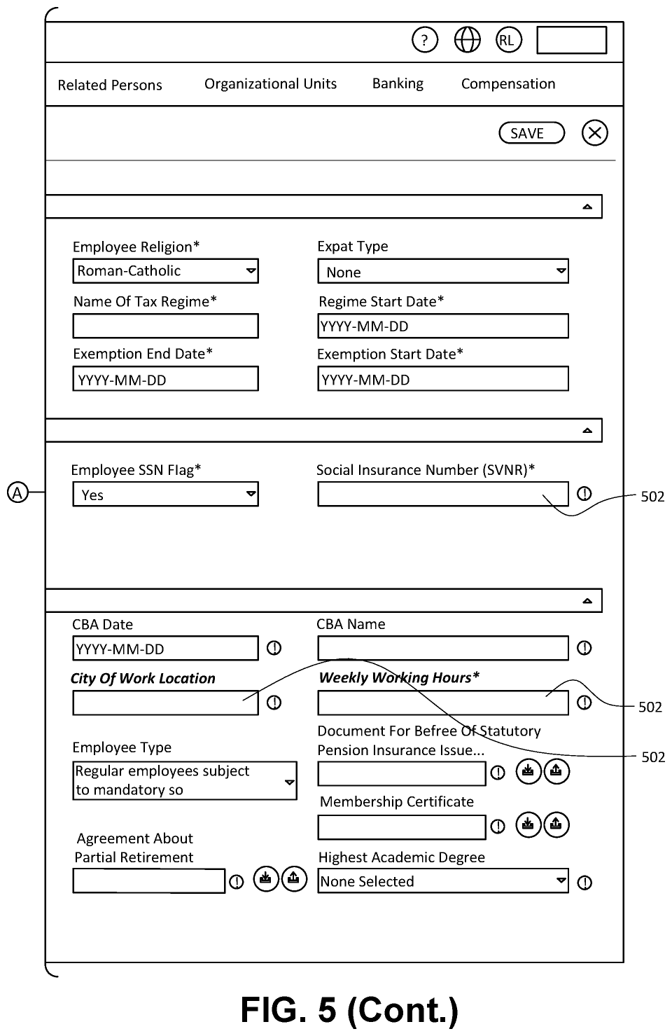

FIG. 5 is a diagram 500 illustrating the GUI depicting erroneous data values. FIG. 5 depicts a window of user interface 126 that is generated when the user selects the “view/edit” option in invalid entry 404. As can be seen, there are several data values collected from the employee. These data values include personal details (e.g., marital status, religion, etc.), national identifiers (e.g., Tax ID, Tax Class, social security number, etc.), and contract information (e.g., contract type, working days, work location, employee type, etc.).

Invalid entry 404 is generated because the employee failed to provide a social security number, city of work location, and weekly working hours. These are marked as error fields 502. In addition, there is a warning generated because the employee failed to provide a state of work location. This is marked as warning field 504. In some aspects, the error fields are visually marked/highlighted by an error icon or a color associated with error (e.g., red). In some aspects, the warning fields are visually marked/highlighted by a warning icon or a color associated with error (e.g., yellow).

It should be noted that the interface shown in FIG. 5 includes additional tabs on the top portion of the window (e.g., person record, job details, addresses, payroll specific, related persons, organizational units, banking, and compensation). A user may select one of these tabs to view that information about the employee. For example, the banking tab may be linked to a window that displays banking information (e.g., bank, account number, routing number, etc.). Errors, warnings, and observations may also be generated based on those data values. For example, if a user provides a routing number that is not linked to a bank, perpetual validation module 108 may generate validation results that highlight the erroneous routing number.

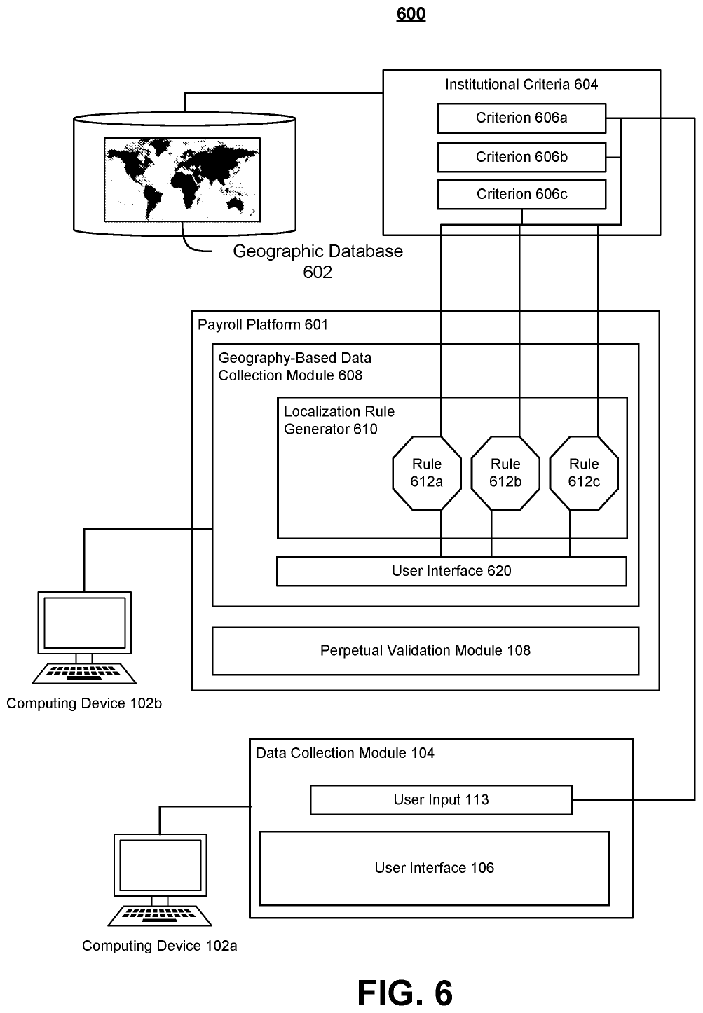

FIG. 6 is a block diagram illustrating a system 600 for configuring rules for geography-based data collection and evaluation. System 600 includes payroll platform 601, which is made up of geography-based data collection module 608, which may execute the CSI framework mentioned previously, and perpetual validation module 108. Geography-based data collection module 608 receives institutional criteria 604 for processing payroll transactions for employees in a first geographic location (e.g., a country such as the United States). The institutional criteria may be unique to the first geographic location from a plurality of geographic locations in geographic database 602. For example, geographic database 602 may list several countries and their individual criterion 606a, 606b, 606c, etc. It should be noted that although only three criterion are shown in FIG. 6, a particular geographic location may have hundreds or thousands of criterion. As laws change in a particular geographic location, geographic database 602 may be manually updated to incorporate new institutional criteria 604.

Geography-based data collection module 608 parses institutional criteria 604 and identifies from a plurality of data types, a subset of data types that correspond to the institutional criteria 604. For example, criterion 606a may be a government-issued identifier such as a social security number. Criterion 606a may also list various attributes of the social security number as metadata. For example, the attributes may indicate that the social security number is nine digits long, is solely numerical, is possessed by US citizens and permanent residents, etc. Criterion 606b may be a date of birth. The attributes of criterion 606b may include that the employee cannot be less than 18 years of age, the date of birth cannot be past the current date, etc. Criterion 606c may be a marital status. The attributes of criterion 606c may indicate that the marital status may be one of: single, married, separated, widowed, divorced, etc. Geography-based data collection module 608 may refer to plurality of data types (e.g., data type 114a, 114b, etc.) to determine a matching data type to the criterion. For example, the plurality of data types may be stored in the memory of the computing device 102b and may include social security number, date of birth, and marital status. In response to determining matches (e.g., by text comparison), geography-based data collection module 608 may identify a subset of data types that correspond to institutional criteria 604. If a match for data type cannot be identified, a new data type may be created by geography-based data collection module 608.

Subsequently, geography-based data collection module 608 generates, using localization rule generator 610, at least one localization rule that assesses whether the institutional criteria 604 is satisfied. For example, geography-based data collection module 608 may generate rule 612a for criterion 606a, rule 612b for criterion 606b, and rule 612c for criterion 606c. These rules may specifically stem from the metadata accompanying institutional criteria 604. For example, rule 612a may be associated with the social security number being a nine digit numerical value. For example, rules 612a, 612b, 612c correspond to rules 116a described previously.

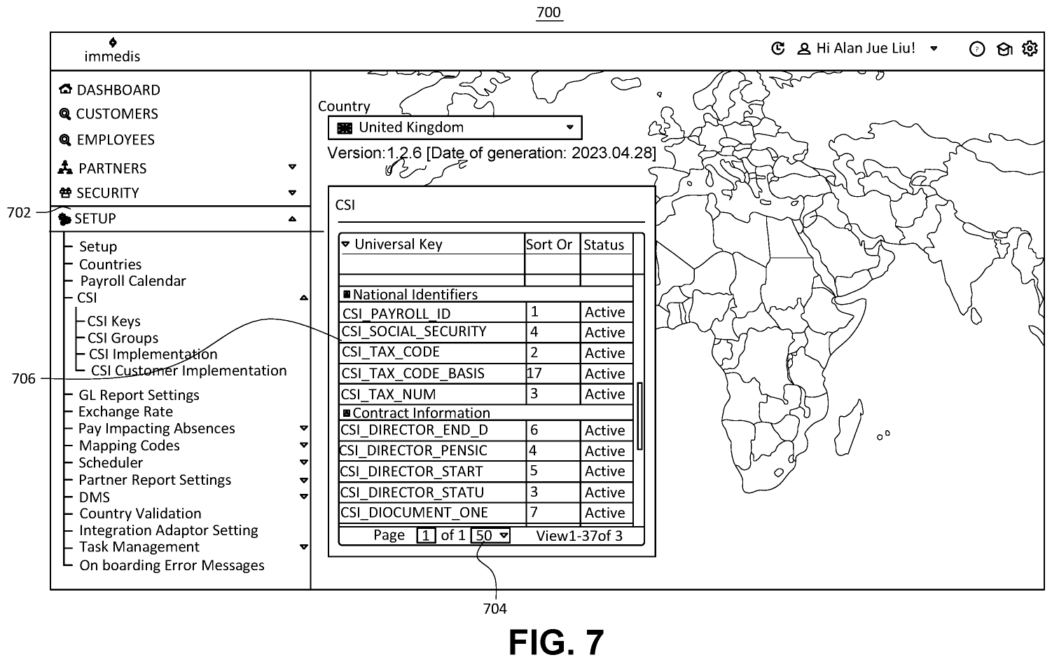

In some aspects, a user of geography-based data collection module 608 may generate and configure rules using user interface 620 of geography-based data collection module 608. Examples of windows of user interface 620 are shown in FIGS. 7-9.

Geography-based data collection module 608 may further generate a graphical user interface 106 that receives data input from an employee via computing device 102a. For example, geography-based data collection module 608 may transfer data entry fields associated with the subset of data types corresponding to institutional criteria 604. In particular, geography-based data collection module 608 may determine whether data collection module 104 is being accessed by an employee in a particular geographic location. In response, geography-based data collection module 608 may configure data collection module 104 to display, from a plurality of data entry fields, solely fields associated with the subset of data types on the graphical user interface 106. Subsequently, in response to receiving at least one entry (i.e., user input 113) in the fields associated with the subset of data types, perpetual validation module 108 may validate the at least one entry using the at least one rule generated by geography-based data collection module 608 (e.g., rule 612a to assess the data type entry corresponding to criterion 606a). The validation process is described in the description of FIG. 1 and will not be recited again for the sake of brevity.

Geography-based data collection module 608 may then generate, on the graphical user interface 106, an error message in response to determining that the at least one entry does not satisfy the institutional criteria 604 of the geographic location associated with the employee. It should be noted that geography-based data collection module 608 may be implemented as a thick client application that runs on computing device 102b, parses criteria, generates rules, and enables rule configuration via user interface 620. Geography-based data collection module 608 may also be implemented as a thin client application that generates user interface 106 based on the data types associated with institutional criteria 604 and receives user input 113. The thin client application may transmit user input 113 for validation by perpetual validation module 108.

In reference to FIGS. 7-9, diagrams 700, 800, and 900 may be windows within user interface 620. In some aspects, user interface 620 and user interface 126 are part of the same graphical user interface.

FIG. 7 is a diagram 700 illustrating the GUI depicting a plurality of data types associated with a geographic location. In order to the window shown in diagram 700, a user may select the rule setup 702 option in the side panel (i.e., navigation interface). Upon selection, geography-based data collection module 608 generates data type window 704, which lists a plurality of data types 706 for a particular geographic location (e.g., the United Kingdom). For example, one data type may be CSI_TAX_CODE, which is a national identifier. In some aspects, certain data types may be inactive depending on whether the criteria is still relevant in the geographic location. For example, a law may change, which causes a data type that is currently active to be made inactive.

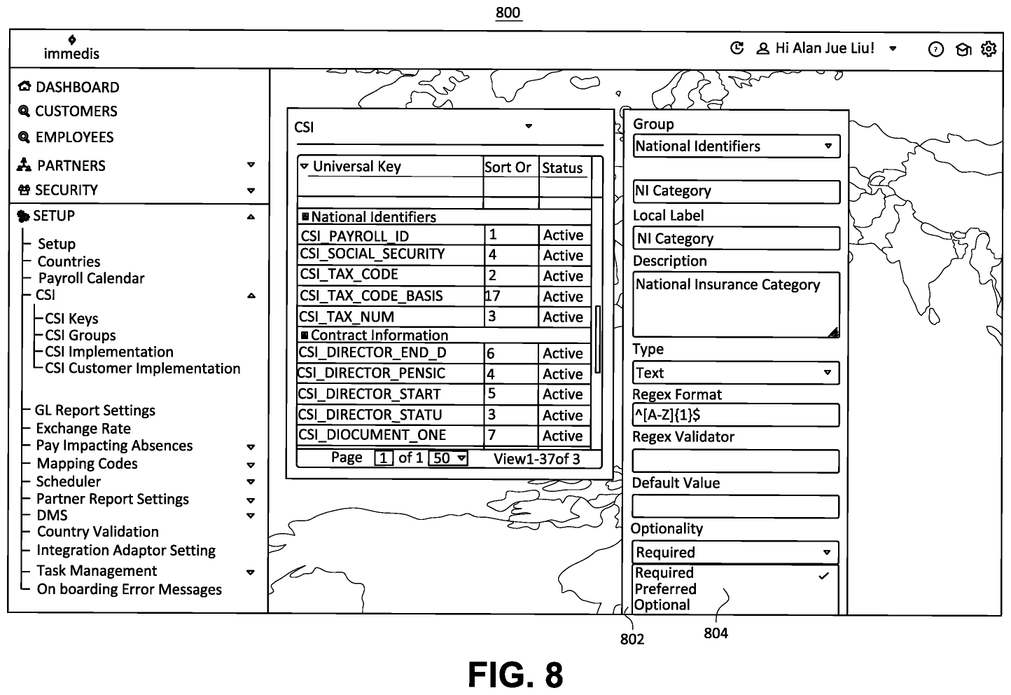

FIG. 8 is a diagram 800 illustrating the GUI depicting data type attributes. For example, a user may select the data type “CSI_SOCIAL_SECURITY,” which generates data type attribute window 802, which lists configurable attributes such as group, global label, local label, etc. Selecting one of the configurable attributes may generate options 804, which lists the possible parameters that a parameter can take. For example, in terms of “optionality,” options 304 lists the following parameters in a dropdown menu: required, preferred, optional.

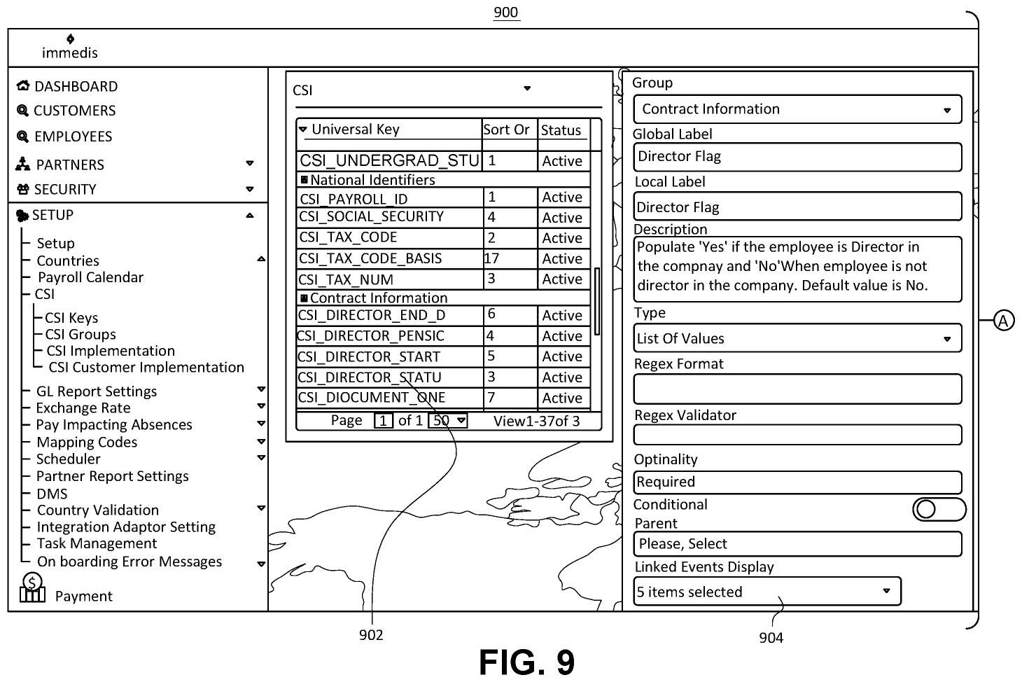

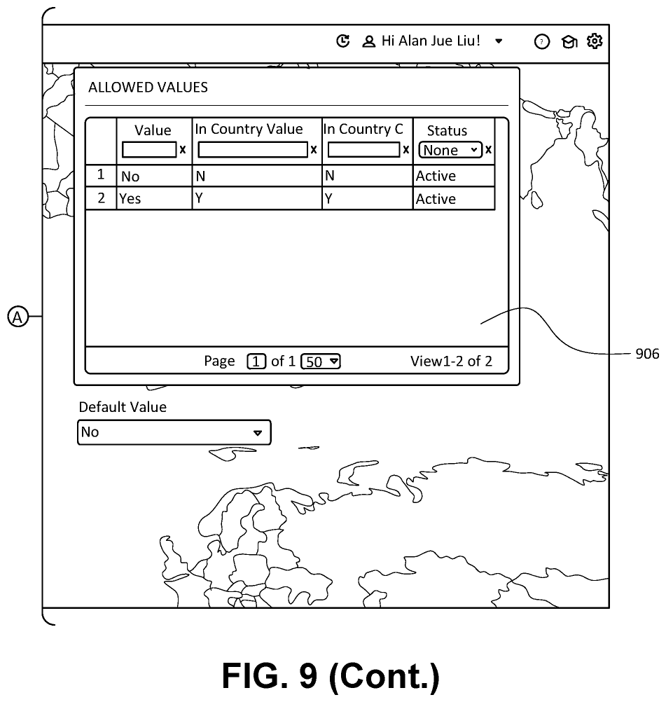

FIG. 9 is a diagram 900 illustrating the GUI depicting rule configuration and generation. Suppose that the selects data type 902 (i.e., CSI_DIRECTOR_STATUS). In response, geography-based data collection module 608 generates data type attributes window 904, which lists various attributes and parameters. One of the options in data type attributes window 904 is to set rules associated with data type 902. For example, rule 906 indicates that an employee can select either yes or no as the director status (i.e., the person is a director or is not). In some aspects, there may be a rule that a given company/office may only have one director. Accordingly, if more than one employees indicate “yes,” an error may be raised by perpetual validation module 108.

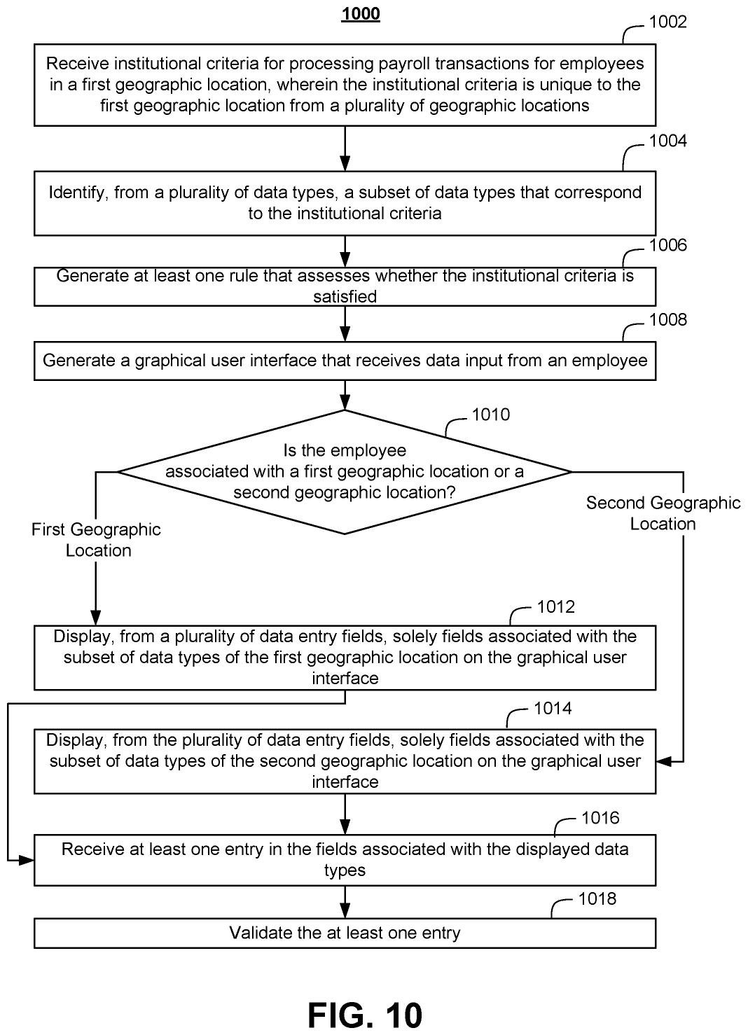

FIG. 10 illustrates a flow diagram of a method 1000 for generating a graphical user interface for geography-based data collection and evaluation.

At 1002, geography-based data collection module 608 receives institutional criteria for processing payroll transactions for employees in a first geographic location. This institutional criteria is unique to the first geographic location, which may be one of a plurality of geographic locations. For example, a given geographic location is one of a town, a city, a country, a continent, etc. The institutional criteria includes a collection of employee information needed for payroll transactions. For example, the institutional criteria may include one or more of: full name, residential address, position, salary, a government-issued identifier, an amount of dependents, years of experience, a contract length, etc. In some aspects, institutional criteria may be set by one or more of a governing body of the geographic location, by the company bylaws, etc.

At 1004, geography-based data collection module 608 identifies, from a plurality of data types, a subset of data types that correspond to the institutional criteria. Suppose that the first geographic location is the United States. The government of the United States may require the following institutional criteria: a first name, a last name, a residential address, a job title, a salary, a marital status, an amount of dependents, a social security number. It should be noted that these are a few of many possible requirements. In contrast, a different geographic location such as Pakistan may further require the full name of the employee's father.

The plurality of data types may include several data types such as: first name, middle name, last name, residential address, company address, email address, phone number, date of birth, driver license number, etc. Geography-based data collection module 608 may identify the matching data types and create a subset of the data types dedicated to the first geographic location (e.g., a first name, a last name, a residential address, a job title, a salary, a marital status, a dependents count, a social security number).

At 1006, geography-based data collection module 608 generates at least one rule that assesses whether the institutional criteria is satisfied. In some aspects, a rule indicates attributes that a data value should have in order to prevent payroll transaction issues. Referring to FIG. 1, the at least one rule may be one of rules 116a and may be linked to data type 114a. Data value 120 may be assessed by perpetual validation module 108 using the rule created by geography-based data collection module 608.

For example, a rule may indicate that a social security number should have nine numerical digits. Another rule may indicate that the social security number should not be provided by non-citizen and non-permanent residents. These rules may be generated using the graphical user interface 620.

At 1008, geography-based data collection module 608 may generate a graphical user interface that receives data input from an employee. For geography-based data collection module 608 may generate user interface 106 on computing device 102a. As mentioned before, geography-based data collection module 608 may be executed as a thick client application on computing device 102b, where a user generates and configures rules using user interface 620 (as further shown in FIGS. 6-9). Data collection module 104 may be a thin client application of geography-based data collection module 608 that displays user interface 104 for collecting employee payroll data.

At 1010, geography-based data collection module 608 may determine whether the employee is associated with the first geographic location or a second geographic location of the plurality of geographic locations. In some aspects, geography-based data collection module 608 may determine that the employee is associated with a particular geographic location based on the employee indicating, via the graphical user interface 106, that the employee works in an office located in the that geographic location or that the employee is a resident of that geographic location. For example, the residential information of the employee or the office location may indicate whether an employee lives in the United States or in Pakistan.

In response to determining that the employee is associated with the first geographic location (e.g., the United States), method 1000 advances to 1012, where geography-based data collection module 608 displays, from a plurality of data entry fields, solely fields associated with the subset of data types of the first geographic location on the graphical user interface 106. This limits the information provided by the user to only information that is required by the first geographic location. Any unused information will not be collected in this manner. Alternatively, in response to determining that the employee is associated with the second geographic location (e.g., Pakistan), method 1000 advances to 1012, where geography-based data collection module 608 displays, from a plurality of data entry fields, solely fields associated with the subset of data types of the second geographic location on the graphical user interface 106.

For example, prior to method 1000, geography-based data collection module 608 may receive different institutional criteria (e.g., including a requirement for a father's name and excluding a requirement for a social security number) for processing payroll transactions for employees in a second geographic location such as Pakistan. Here, the different institutional criteria is unique to the second geographic location. Geography-based data collection module 608 may again identify, from the plurality of data types, a different subset of data types that correspond to the different institutional criteria, and generate at least one other rule that assesses whether the different institutional criteria is satisfied. For example, the data type may be paternal parent/guardian name. The at least one rule may include a first rule that each employee is required to provide the paternal parent/guardian name, a second rule that the name cannot have numbers or symbols, a third rule may indicate that the name should be more than one character long, etc.

From 1012 and 1014, method 1000 advances to 1016, where geography-based data collection module 608 receives at least one entry in the fields associated with the displayed data types. For example, user interface 106 may generate an input page with a plurality of fields configured to receive text. Each respective field may be visually marked with the data type of the requested information. For example, a first field may be accompanied by the text “first name,” and a second field may be accompanied by the text “date of birth.” Accordingly, the user is expected to enter their first name in the first field and their date of birth in the second field. In response to receiving the entries from the user, method 1000 may invoke perpetual validation module 108 to validate the at least one entry using the at least one rule. In some aspects, geography-based data collection module 608 may also store the at least one entry in a database of the at least one memory.

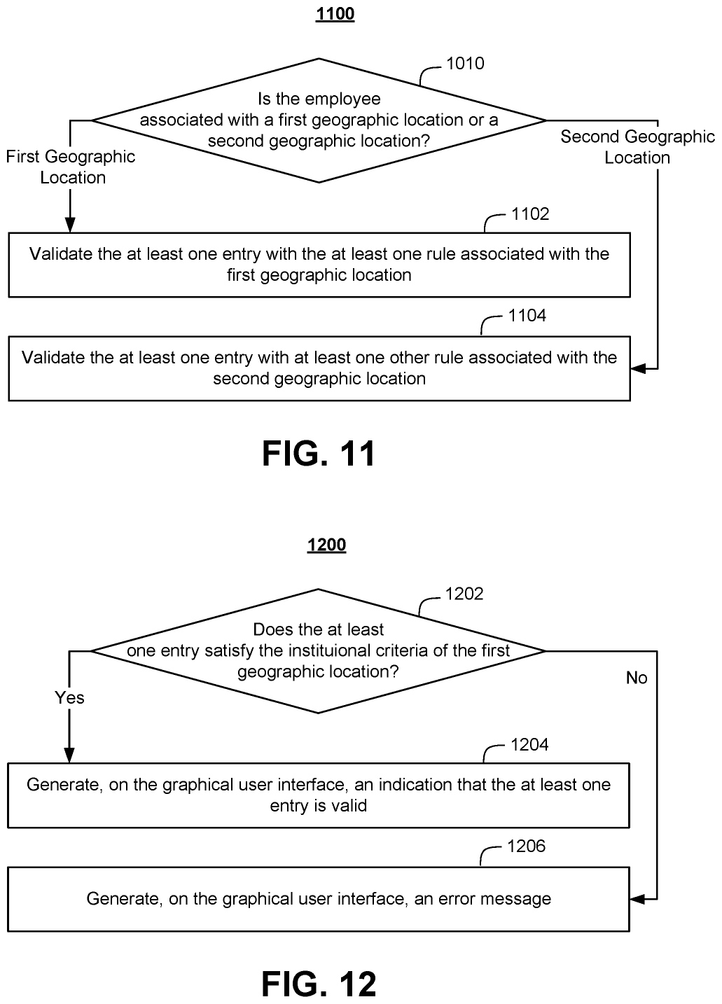

FIG. 11 illustrates a flow diagram of a method 1100 for validating an employee entry based on a localization rule. Method 1100 may be executed when step 1010 of method 1000 is executed. In response to the employee being associated with the first geographic location, at 1102, perpetual validation module 108 validates the at least one entry with the at least one rule associated with the first geographic location. In response to the employee being associated with the second geographic location, at 1104, perpetual validation module 108 validates the at least one entry with the at least one other rule associated with the second geographic location. For example, if the data type is a government issued number (e.g., a driver license), the number requirements in the first geographic location may be different than the number requirements in the second geographic location. Accordingly, the inputted number needs to be associated with which location the employee is associated with.

This may also be because each data type is processed differently in the payroll transaction for the first geographic location than when processed for a second geographic location. For example, if the first geographic location is a country such as the United States and the second geographic location is a country such as Canada, their tax code are different. The functions that estimate tax may receive the same/similar data types, but generate different outcomes.

FIG. 12 illustrates a flow diagram of a method 1200 for generating a validation result. At 1202, perpetual validation module 108 determines whether the at least one entry satisfies the institutional criteria of the first geographic location. In order to satisfy the institutional criteria, the data values in the at least one entry must satisfy the criteria of the plurality of rules associated with the data value types and the geographic location. In response to determining that the institutional criteria is satisfied, method 1200 advances to 1204, where perpetual validation module 108 generates on the graphical user interface (e.g., user interface 106) an indication that the at least one entry is valid. As mentioned before, validation in the context of the present disclosure is performed in real-time. In addition to the company receiving validation results via user interface 126, the employee entering the data may also receive real-time notifications via user interface 106. In response to determining that the institutional criteria is not satisfied, method 1200 advances to 1206, where perpetual validation module 108 generates an error message on user interface 106. For example, the error message may be a visual cue that a data value provided by the employee is incorrect. The visual cue may be comparable to the error field shown in FIG. 5.

In some aspects, when the at least one entry satisfies the institutional criteria of the first geographic location, geography-based data collection module 608 may enable/execute a payroll transaction of the employee in the first geographic location. For example, geography-based data collection module 608 may enable the employee to receive a direct deposit of their salary.

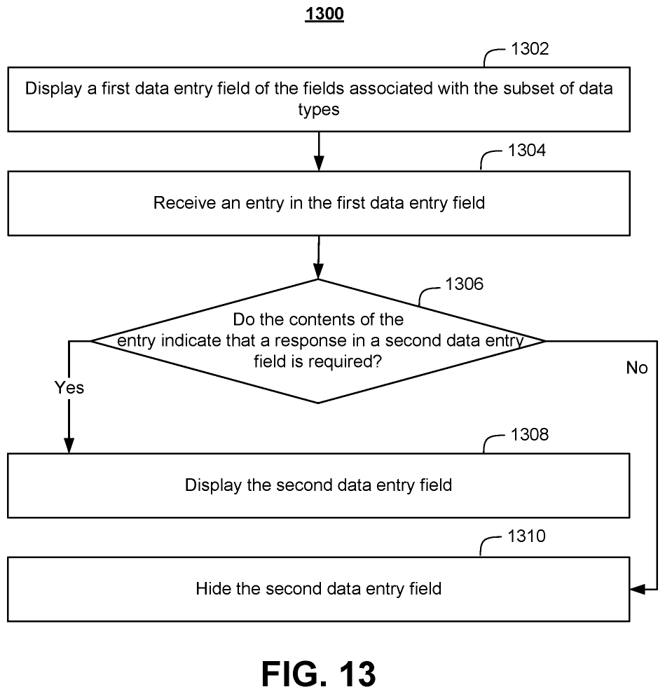

FIG. 13 illustrates a flow diagram of a method 1300 for displaying entry fields on the graphical user interface based on the contents of a previously received entry. Method 1300 may be executed during steps 1012 and 1014 of method 1000.

At 1302, geography-based data collection module 608 displays on user interface 106 a first data entry field of the fields associated with the subset of data types. For example, a data value may be citizenship status. The first data entry field may thus request the citizenship status of the employee.

At 1304, geography-based data collection module 608 receives an entry in the first data entry field. For example, the employee may enter “US citizen” or select the entry from a drop down menu of the first data entry field listing a plurality of selectable options.

At 1306, geography-based data collection module 608 determines whether the contents of the entry indicate that a response in the second data entry field is required. For example, the second data entry field may be for entering a social security number. Geography-based data collection module 608 may analyze the rules associated with the data type associated with the second data entry field. For example, geography-based data collection module 608 may determine that a rule indicates that a US citizen is required to provide a social security number. In response to determining that the contents of the entry indicate that the response in the second data entry field is required, method 1300 may advance to 1308, where geography-based data collection module 608 displays second data entry field on the user interface 106. However, if the second data entry is not required, method 1300 advances to 1310, where geography-based data collection module 608 hides the second data entry field on the user interface 106. For example, geography-based data collection module 608 may not generate the field, may generate the field but block inputs into the field, or may generate the field but visually mark it is not required.

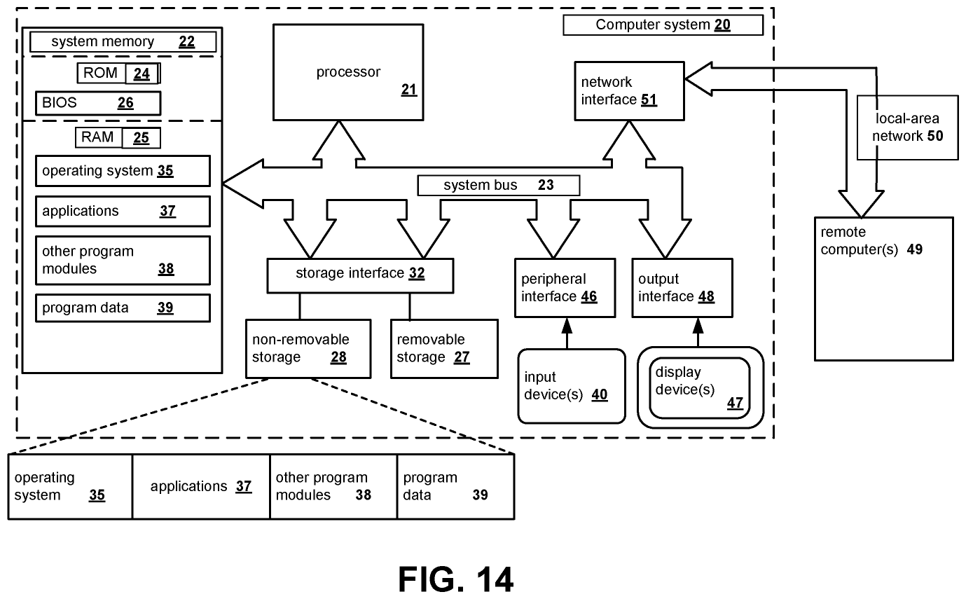

FIG. 14 is a block diagram illustrating a computer system 20 on which aspects of systems and methods for payroll data validation may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-13 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A system for geography-based data collection and evaluation, comprising:
at least one memory;
at least one hardware processor coupled with the at least one memory and configured, individually or in combination, to:
receive institutional criteria for processing payroll transactions for employees in a first geographic location, wherein the institutional criteria is unique to the first geographic location from a plurality of geographic locations;
identify, from a plurality of data types, a subset of data types that correspond to the institutional criteria;
generate at least one rule that assesses whether the institutional criteria is satisfied;
generate a graphical user interface that receives data input from an employee;
display, from a plurality of data entry fields, solely fields associated with the subset of data types on the graphical user interface in response to determining that the employee is associated with the first geographic location;
in response to receiving at least one entry in the fields associated with the subset of data types, validate the at least one entry using the at least one rule; and
generate, on the graphical user interface, an error message in response to determining that the at least one entry does not satisfy the institutional criteria of the first geographic location.

2. The system of claim 1, wherein the at least one hardware processor is configured to determine that the employee is associated with the first geographic location based on the employee indicating, via the graphical user interface, that the employee works in an office located in the first geographic location or that the employee is a resident of the first geographic location.

3. The system of claim 1, wherein the institutional criteria includes one or more of: name, address, position, salary, a government-issued identifier, an amount of dependents, years of experience, a contract length.

4. The system of claim 1, wherein the at least one hardware processor is configured to display the fields associated with the subset of data types by:
displaying a first data entry field of the fields associated with the subset of data types;
receiving an entry in the first data entry field; and
displaying one of a second data entry field or a third data entry field based on contents of the entry received.

5. The system of claim 4, wherein the at least one hardware processor is configured to:
display the second data entry field and hide the third data entry field in response to determining that the contents of the entry indicate that a response in the third data entry field is not required in accordance with the institutional criteria.

6. The system of claim 1, wherein the at least one hardware processor is configured to:
receive different institutional criteria for processing payroll transactions for employees in a second geographic location, wherein the different institutional criteria is unique to the second geographic location from the plurality of geographic locations;
identify, from the plurality of data types, a different subset of data types that correspond to the different institutional criteria; and
generate at least one other rule that assesses whether the different institutional criteria is satisfied.

7. The system of claim 6, wherein the at least one hardware processor is further configured to:
generate the graphical user interface that receives data input from an employee, by:
displaying, from the plurality of data entry fields, solely fields associated with the different subset of data types in response to determining that the employee is associated with the second geographic location instead of the first geographic location.

8. The system of claim 1, wherein the at least one hardware processor is further configured to store the at least one entry in a database of the at least one memory.

9. The system of claim 1, wherein a given geographic location is one of a town, a city, a country, and a continent.

10. The system of claim 1, wherein the at least one hardware processor is configured to execute a payroll transaction in response to determining that the at least one entry satisfies the institutional criteria of the first geographic location.

11. The system of claim 10, wherein a data type is processed differently in the payroll transaction for the first geographic location than when processed for a second geographic location.

12. A method for geography-based data collection and evaluation, comprising:
receiving institutional criteria for processing payroll transactions for employees in a first geographic location, wherein the institutional criteria is unique to the first geographic location from a plurality of geographic locations;
identifying, from a plurality of data types, a subset of data types that correspond to the institutional criteria;
generating at least one rule that assesses whether the institutional criteria is satisfied;
generating a graphical user interface that receives data input from an employee;
displaying, from a plurality of data entry fields, solely fields associated with the subset of data types on the graphical user interface in response to determining that the employee is associated with the first geographic location;
in response to receiving at least one entry in the fields associated with the subset of data types, validating the at least one entry using the at least one rule; and
generating, on the graphical user interface, an error message in response to determining that the at least one entry does not satisfy the institutional criteria of the first geographic location.

13. The method of claim 12, further comprising determining that the employee is associated with the first geographic location based on the employee indicating, via the graphical user interface, that the employee works in an office located in the first geographic location or that the employee is a resident of the first geographic location.

14. The method of claim 12, wherein the institutional criteria includes one or more of: name, address, position, salary, a government-issued identifier, an amount of dependents, years of experience, a contract length.

15. The method of claim 12, further comprising displaying the fields associated with the subset of data types by:
displaying a first data entry field of the fields associated with the subset of data types;
receiving an entry in the first data entry field; and
displaying one of a second data entry field or a third data entry field based on contents of the entry received.

16. The method of claim 15, further comprising:
displaying the second data entry field and hide the third data entry field in response to determining that the contents of the entry indicate that a response in the third data entry field is not required in accordance with the institutional criteria.

17. The method of claim 12, further comprising:
receiving different institutional criteria for processing payroll transactions for employees in a second geographic location, wherein the different institutional criteria is unique to the second geographic location from the plurality of geographic locations;
identifying, from the plurality of data types, a different subset of data types that correspond to the different institutional criteria; and
generating at least one other rule that assesses whether the different institutional criteria is satisfied.

18. The method of claim 17, further comprising:
displaying, from the plurality of data entry fields, solely fields associated with the different subset of data types in response to determining that the employee is associated with the second geographic location instead of the first geographic location.

19. The method of claim 1, further comprising storing the at least one entry in a database of the at least one memory.

20. A non-transitory computer readable medium storing thereon computer executable instructions for payroll data validation, including instructions for:
receiving institutional criteria for processing payroll transactions for employees in a first geographic location, wherein the institutional criteria is unique to the first geographic location from a plurality of geographic locations;
identifying, from a plurality of data types, a subset of data types that correspond to the institutional criteria;
generating at least one rule that assesses whether the institutional criteria is satisfied;
generating a graphical user interface that receives data input from an employee;
displaying, from a plurality of data entry fields, solely fields associated with the subset of data types on the graphical user interface in response to determining that the employee is associated with the first geographic location;
in response to receiving at least one entry in the fields associated with the subset of data types, validating the at least one entry using the at least one rule; and
generating, on the graphical user interface, an error message in response to determining that the at least one entry does not satisfy the institutional criteria of the first geographic location.
